(19) United States
(12) Patent Application Publication
(10) Pub. No.: US 2015/0074820 A1
(43) Pub. Date: Mar. 12, 2015

(54) SECURITY ENHANCEMENT APPARATUS

(71) Applicant: National Institute of Advanced Industrial Science and Technology, Tokyo (JP)

(72) Inventors: Kenji TODA, Tsukuba-shi (JP); Ichirou EBIHARA, Tsukuba-shi (JP); Koji SEGAWA, Tsukuba-shi (JP); Koichi TAKAHASHI, Tsukuba-shi (JP); Osamu MORIKAWA, Tsukuba-shi (JP); Kazukuni KOBARA, Tsukuba-shi (JP)

(73) Assignee: National Institute of Advanced Industrial Science and Technology, Tokyo (JP)

(21) Appl. No.: 14/199,458

(22) Filed: Aug. 26, 2014

(30) Foreign Application Priority Data
Sep. 6, 2013 (JP) 2013-185768

(51) Int. Cl. G06F 21/62

(52) U.S. Cl. CPC G06F 21/6218
USPC 726/27

(57) ABSTRACT

A security enhancement apparatus is provided which is capable of preventing infection by malware that requires writing of important files of the OS or system, by protecting the important files from writing if data protection is implemented in units of files. The security enhancement apparatus relays IO of a PC, control device, or the like. A hard disk, USB device, display, or the like is connected via the security enhance apparatus. As for data protection in a storage, data is handled not only in units of sectors but also in units of files. The apparatus directly performs secure data transfer or display, setting/input therefor, or the like, thereby being able to correctly make an alert or inquiry to the user even in the case where a vulnerability of the OS or application program is attacked and control of the PC or control device is taken by an unauthorized program. Also, during communication, the security enhancement apparatus can authenticate a communication-partner device and encrypt communication content.

### BACKGROUND OF THE INVENTION

### Field of the Invention

The present invention relates to a security enhancement apparatus.

Write prohibition and read prohibition of data are generally implemented by software such as the OS or application program. However, because various vulnerabilities exist in complicated software, malware may enter from a network and infect the software. Consequently, the case where unauthorized data access is overlooked often occurs.

Hardware data protection means is implemented by a write prohibition switch which is attached to an SD card, floppy disk, encased magnetic tape medium, or the like. Also, apparatuses that prohibit writing when being connected to a hard disk are commercially available. However, these means each prohibit writing on a medium-by-medium basis. This is different from a method for protecting data on an area-by-area basis, such as on a sector-by-sector basis.

As for network communication, devices that are connected to an Ethernet port and are capable of encrypting communication from a PC are commercially available. However, in the case where a plurality of devices perform encrypted communication, setup needs to be performed for each device, and such setup for the plurality of devices and update performed at the time of addition of a device or the like require significant efforts.

### CITATION LIST

### Non-Patent References

[Non-patent Reference 1] Brian Carrier: File System Forensic Analysis, Addison Wesley Professional, ISBN: 0-32-126817-2, Mar. 17, 2005.
[Non-patent Reference 2] Hirokazu Takahashi and Kazuto Miyoshi, “Linux Kernel 2.4 no Sekkei to Jissou 6 Fairu Shisutemu (Zenpen) (The Design and Implementation of Linux Kernel 2.4 6 File System (First part)),” Linux Japan, pp. 171-196, April 2001.
[Non-patent Reference 3] Hirokazu Takahashi and Kazuto Miyoshi, “Linux Kernel 2.4 no Sekkei to Jissou 7 Fairu Shisutemu (Kouhen) (The Design and Implementation of Linux Kernel 2.4 7 File System (Latter part),” Linux Japan, pp. 139-164, My 2001.

### SUMMARY OF THE INVENTION

Protection of data performed in units of files is roughly categorized into write prohibition and read prohibition. The file systems differ from OS to OS, and there are many kinds of file system. In each file system, in the case of implementing read prohibition, a sector storing data is checked, and read prohibition is recorded in security information therefor. On the other hand, in the case of implementing write prohibition, when a sector storing data is directly rewritten, the sector storing the data is checked, and write prohibition is recorded in security information therefor as in the case of read prohibition. However, in major file systems often used in PCs or the like (such as EXT2, FAT, and NTFS having directories of a hierarchical structure), because a new file is separately created and rewriting of a directory is performed lastly at the time of writing depending on the application program, it is not sufficient to monitor only the sector storing the data. Also, the same applies to the case where any part of a path from the root to the file is rewritten.

The present invention has been proposed in view of the issues described above. Specifically, the present invention discloses a file-by-file data protection method and a secure network utilization method. Also, if data protection can be implemented in units of files, it becomes possible to prevent infection by malware that requires rewriting of important files of the OS or system, by protecting the important files from writing. This is different from a method for protecting data in units of areas such as sectors.

To achieve the aforementioned object, there is provided a security enhancement apparatus that makes a resolution of security information higher than a resolution of sectors which are units of IO of a block device, and that implements access control of write prohibition or read prohibition in areas smaller than the sectors.

To achieve the aforementioned object, the security enhancement apparatus according to the present invention is characterized in that the security enhancement apparatus is capable of setting a specified file to be a write-prohibited file, and in a case where there is a write request for the write-prohibited file, does not perform writing for the write-prohibited file, and that information about the request is recorded and a user is notified that the request has been prohibited.

The security enhancement apparatus according to the present invention is characterized in that the security enhancement apparatus is capable of setting a specified file to be a read-prohibited file, and in a case where there is a read request for the read-prohibited file, does not perform reading in an area of the read-prohibited file, and that dummy data is returned, information about the request is recorded, and a user is notified that the request has been prohibited.

The security enhancement apparatus according to the present invention is characterized in that the security enhancement apparatus is capable of setting a specified data file to be subjected to a write inquiry or read inquiry, and has a function of making an inquiry to a user as to whether or not to permit writing or reading in a case where there is a write request or read request for the data file, and of performing writing or reading only in a case where permission is returned.

The security enhancement apparatus according to the present invention includes, as means for specifying security of write prohibition/write inquiry/read prohibition/read inquiry for a given number of files or a file of a given size, a storage component for holding security information in addition to a storage component for holding data, and is characterized in that, for each unit of storage of the storage component for holding data, corresponding security information is held in the storage component for holding security information, and in a case where a request to access the data occurs, the security enhancement apparatus refers to the security information corresponding to a storage area for storing the data and operates in accordance with the security information.

The security enhancement apparatus according to the present invention is characterized in that the storage component for holding data is also used as the storage component for holding security information, a portion of a storage area of the storage component for holding data is an area that is not used as a data area and is invisible from an OS or application program on a PC, and the security information is held in the area.

The security enhancement apparatus according to the present invention is characterized in that various TO ports are directly controlled by hardware so that the control is not sensed from an OS or application program on a PC, the control of the IO ports is mutually coordinated based on information obtained from the IO ports, and in a case where there is an access violating a protection setting for a data area or file, a network visible from the PC and a control device is disconnected and secure communication can be performed even in such a case.

The security enhancement apparatus according to the present invention is configured in the above-described manner. With this configuration, security information can be independently held within a hardware apparatus of a storage apparatus and write prohibition and read prohibition of data can be implemented in units of files. Also, because the protection function cannot be controlled from the OS or application program at all, the data is secure.

### BRIEF DESCRIPTION OF THE DRAWINGS

FIG. 1 A diagram illustrating a first embodiment of a security enhancement apparatus according to an embodiment of the present invention.

FIG. 2 A diagram illustrating a second embodiment of the security enhancement apparatus according to the embodiment of the present invention.

FIG. 3 A diagram illustrating the overview of a conventional control system.

FIG. 4 A diagram illustrating the security enhancement apparatus according to the embodiment of the present invention and issues of the control system.

FIG. 5 A diagram illustrating a connection form of the security enhancement apparatus according to the embodiment of the present invention.

FIG. 6 A conceptual diagram of enhancement of communication security by the security enhancement apparatus according to the embodiment of the present invention.

FIG. 7 A conceptual diagram of enhancement of data access security by the security enhancement apparatus according to the embodiment of the present invention.

FIG. 8 A diagram illustrating an example of access control performed by the security enhancement apparatus according to the embodiment of the present invention in an EXT2 file system.

FIG. 9 A diagram illustrating connections between the security enhancement apparatus according to the embodiment of the present invention and protection-target devices.

FIG. 10 A diagram illustrating the configuration of a security tag in the security enhancement apparatus according to the embodiment of the present invention.

FIG. 11 A diagram illustrating the concept of the security enhancement apparatus according to the embodiment of the present invention.

FIG. 12 A diagram illustrating a mechanism of a data protection function of the security enhancement apparatus according to the embodiment of the present invention.

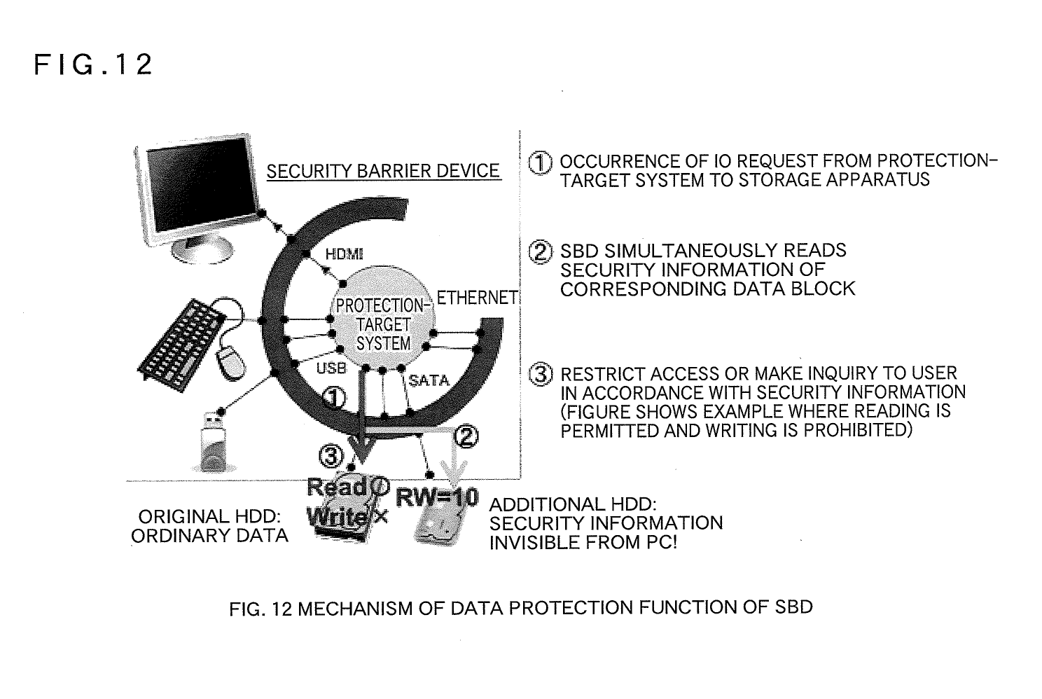

FIG. 13 A diagram illustrating an FPGA board for the security enhancement apparatus according to the embodiment of the present invention.

FIG. 14 A diagram illustrating the security enhancement apparatus according to the embodiment of the present invention.

FIG. 15 A diagram illustrating a connection form of the security enhancement apparatus according to the embodiment of the present invention.

FIG. 16 A diagram illustrating an NTFS file map.

FIG. 17 A diagram illustrating an NTFS map of $MFT and $MFTMirr.

FIG. 18 A diagram illustrating an NTFS directory map.

FIG. 19 A diagram illustrating a method for implementing protection in units of files.

### DESCRIPTION OF THE PREFERRED EMBODIMENTS

Next, embodiments of the present invention will be described based on the drawings.

### INTRODUCTION

Present major social infrastructures such as production systems of factories, plants, or the like, railway/traffic systems, wireless communication networks for mobile phones or the like, various information services such as computer networks or clouds using the networks are constructed on a foundation of control systems. Hitherto, damage has often been caused by phishing, computer viruses, cyber-attacks, and so on, and measures thereagainst have been taken in information systems. However, attacks on control systems of factories, communication networks, and so on have rarely occurred, and measures against such attacks have not been considered to be important. A reason for this is that attacks on control systems are hardly related to personal profits. Also, another reason is that, because many control systems have adopted their unique OS or their unique communication protocols, all tools for the attack are not available and it is difficult to make an attack readily.

However, the presence of malware called Stuxnet, which had kept many centrifuges used for uranium enrichment out of order in a certain nuclear facility for a long time, has been revealed, and vulnerabilities of industrial control devices have been recognized. This is a serious threat to the social infrastructures such those of industry, military, transport, and electric power. In Japan, attacks by malware have been discovered, and it has become an urgent necessity to take measures against them.

<Characteristics of Control System>

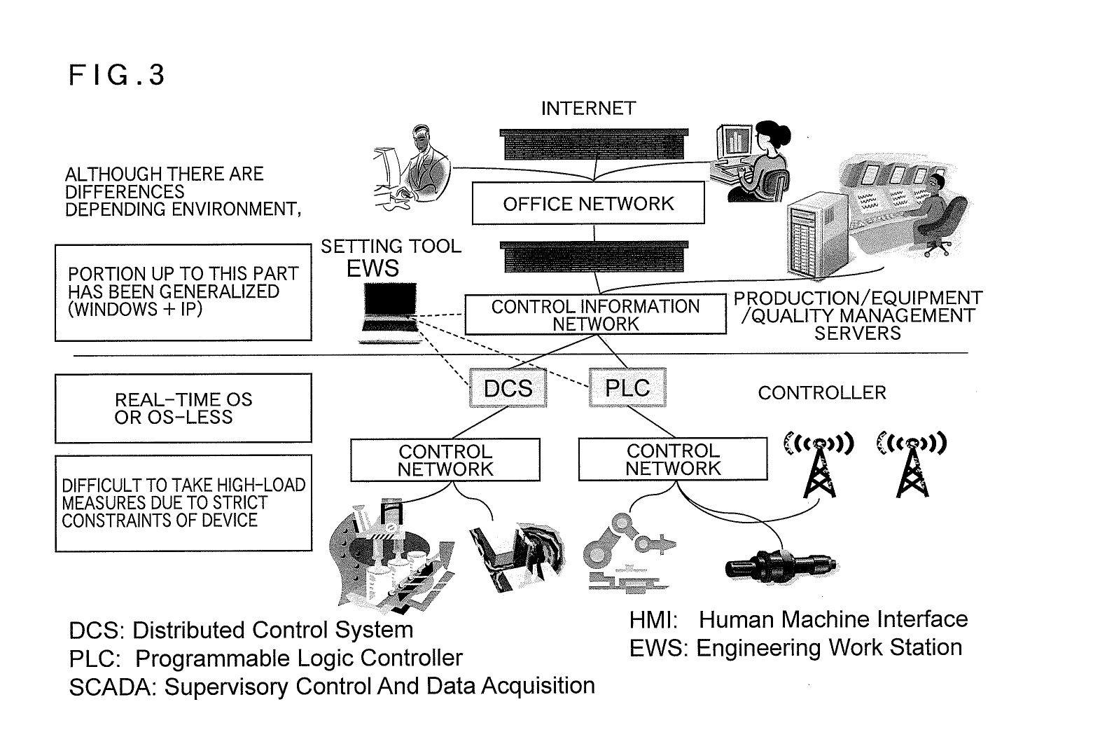

A general configuration of a control system is illustrated in FIG. 3. Specifically, devices that perform physical control at a factory or plant are connected to a DCS (Distributed Control System) and a PLC (Programmable Logic Controller) that control the devices using control networks. At a higher layer thereof, an engineering PC used to perform programming in the DCS and the PLC using a control information network is connected. At a higher layer thereof, office PCs or the like are connected via a firewall. The office PCs are connected to the external Internet via a higher-layer firewall.

In order to improve security of the control system, security measures for these control-information-network devices are mainly needed. Characteristics of the control-information-network devices are as follows:

Importance is placed on availability (operation should not be stopped)

Importance is placed on response time (real-time processing)

Processing requiring a heavy load is difficult (because of resources of the devices or real-time processing)

Update of a program is difficult (because of availability, real-time processing, and resources)

The devices are used for a long time (10 years to 20 years)

A unique OS or a unique protocol is used

A general-purpose PC or open standard is adopted in the controller.

Damage caused at the time of a system failure is large

The devices may be subjected to highly targeted attacks

Malware may break into the control network constituted by the PLC (Programmable Logic Controller), the engineering PC through which programming is performed in the PLC, and the like from an external network or USB memory that is connected for maintenance or the like. Nevertheless, vulnerabilities such as backdoors, insufficient encryption or authentication, or weak passwords have been found in PLCs in Japan, the United States, and Europe, and it has become an urgent necessity to take measures against them (US ICS-CERT and IPA, “Alerts on vulnerabilities of control devices”, Feb. 29, 2012). However, to take actions against vulnerabilities by updating the OS or application program of the device constituting the control network is not easy because of the device's limited processing ability and a difficulty in verification of operation of the already-installed control system. The threats of highly targeted attacks on control systems, notably the one by Stuxnet, are increasing, and measures against attacks, such as zero-day attacks, to vulnerabilities that are yet to be dealt with are also desired.

The present invention that solves the issues described above provides a security enhancement apparatus (add-on apparatus for security=security barrier device (SBD)) that is easily applicable to existing control systems. The SBD is connected to devices on the control network and interconnects IO ports of the devices, whereby any extra load is not put on the devices and the performance is maintained. The SBD is a hardware device serving as a security protective barrier that overcomes the vulnerabilities described above.

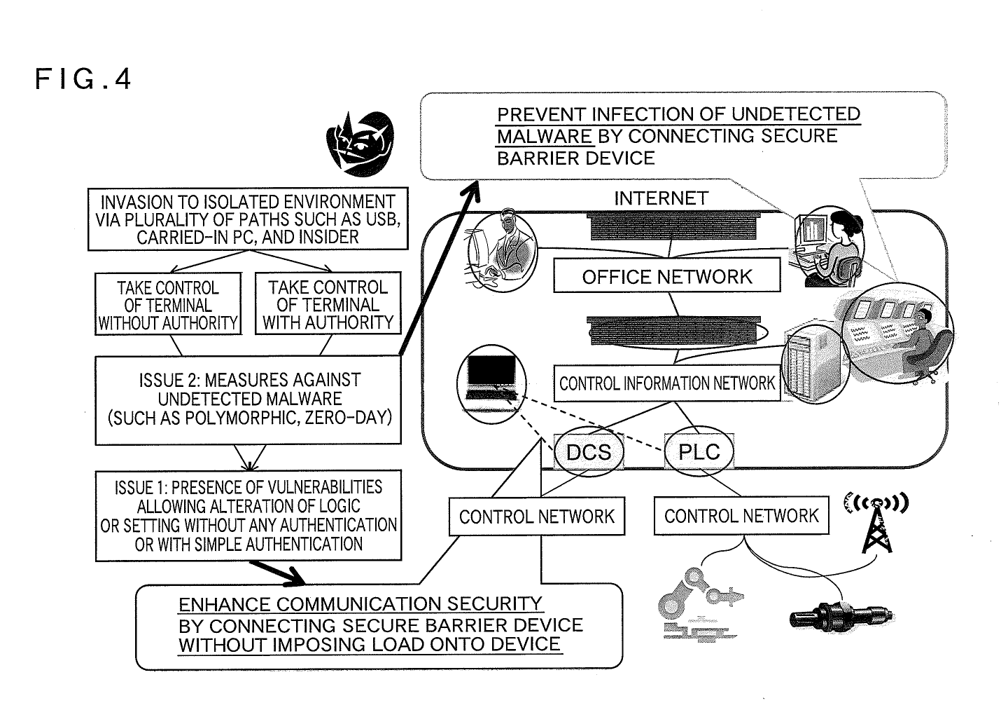

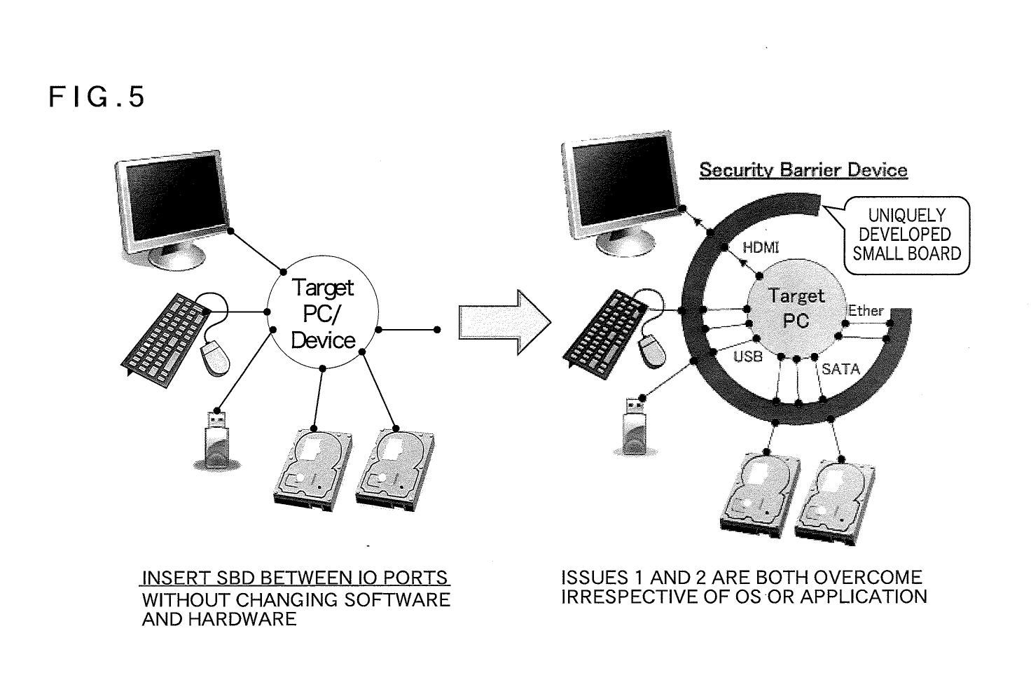

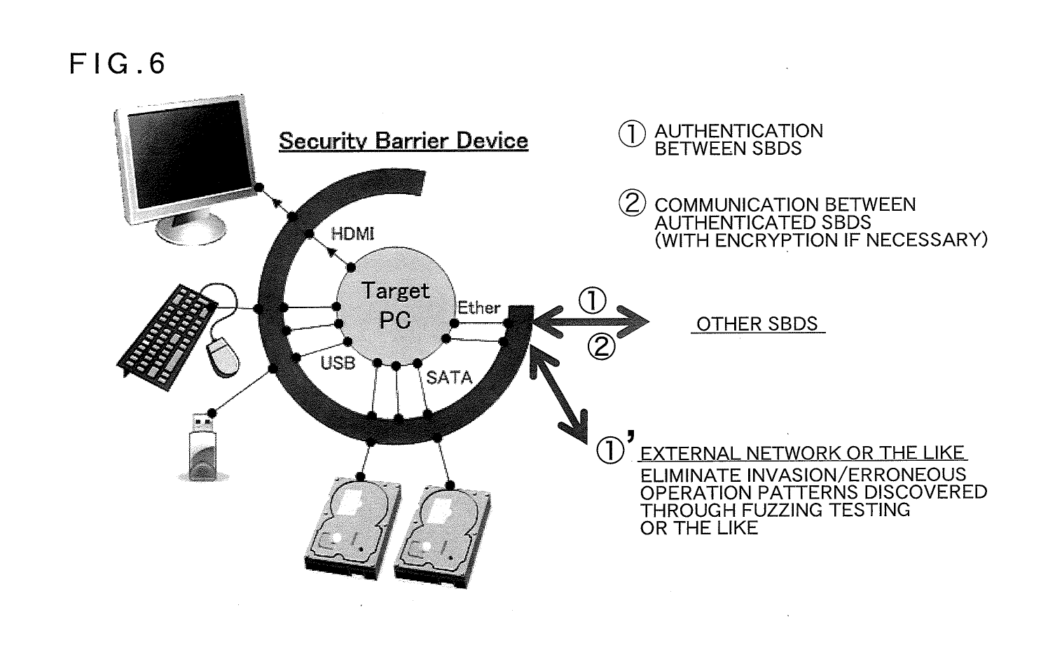

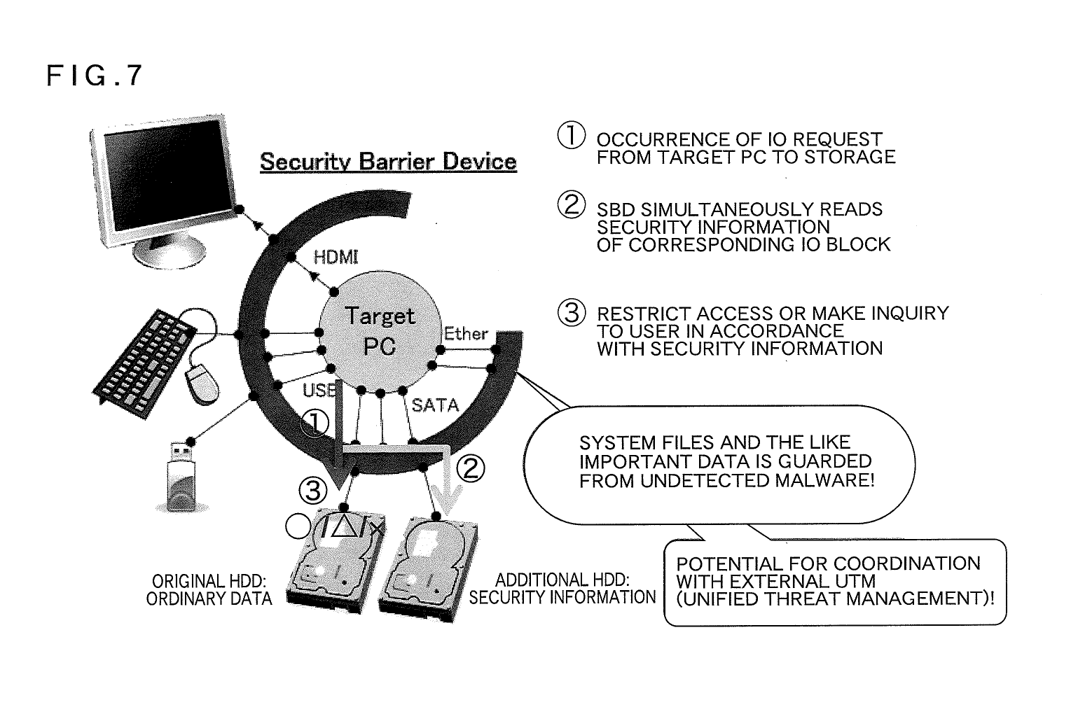

The SBD can be connected to the PLC and the engineering PC through which programming is performed in the PLC without installation of software regardless of whether the software is the OS or application program, and interconnects IO ports based on Ethernet, USB, SATA, HDMI, or the like. At interconnections of IO ports, security of communication is enhanced using authentication and encryption, and access to important files stored in a USB or SATA storage is recorded or controlled. The SBD has a function for requesting the user to make a confirmation via a display, keyboard, or the like when needed. These functions of the SBD can prevent unauthorized apparatuses from being connected to the control network. Also, the SBD has a function for preventing malware from infecting authorized apparatuses and for enhancing security of the control network (see FIG. 4). How the SBD is connected to a protection-target PC and devices is illustrated in FIG. 5. As for enhancement of communication security, authentication is performed between the attached SBDs and encrypted communication is performed between the SBDs if necessary, whereby the protection-target devices communicate with each other as illustrated in FIG. 6. It is also possible to filter communication patterns that cause invasion and erroneous operations and that are determined through fuzzing testing (means for supplying the system with unexpected inputs so as to discover vulnerabilities of the system), using the SBD. As for enhancement of data access security, in addition to the original storage, a dedicated storage that stores security information (which is an implementation example and need not be an independent device) is added as illustrated in FIG. 7. In response to occurrence of an IO from the protection-target device to the original storage, the SBD reads out security information of an IO block corresponding to the additional storage (invisible from the protection-target apparatus). The SBD has a function for restricting access (such as prohibiting reading and prohibiting writing) or making an inquiry to the user in accordance with the security information. This function is implemented by the SBD independently of the protection-target device. For this reason, this function is not detected by the malware, and can prevent information breaches or rewriting of important information by malware. Accordingly, it is considered that targeted attacks for sufficiently collecting information on the attack target and zero-day attacks for attacking vulnerabilities that are yet to be dealt with can be addressed. Note that what is provided by the SBD is access control to the storage, and thus the following needs to be considered for a file system in which data is cached in a memory.

<Access Control in Units of Areas>

An HDD/SSD/USB memory or the like is assumed as the storage device. All of these are block devices, and their unit of access is 512 B which is the ATA sector size. Accordingly, by providing access control information on a sector-by-sector basis (in an additional disk or the like as described before), access control in units of sectors is implemented. Therefore, access control in units of partitions of a disk is easily implemented, and adjustment at the OS side at that time involves a few issues. Data or system files that should not be rewritten are collected in a write-prohibited partition, or data that should not usually be read out is collected in a read-prohibited partition. If there is unauthorized access to these partitions, such access is detected, and a log is recorded by the SBD and is utilized to detect an unauthorized operation or malware.

<Overview of Access Control in Units of Files>

The aforementioned access control in units of areas requires organization of data on a partition-by-partition basis. In contrast, if access control in units of files can be done, the original storage can be made secure without any additional processing. Control devices based on the EXT series (such as Linux), the NTFS (such as Windows series, USB memory), and the FAT series (such as old Windows, MS-DOS, VxWorks, USB memory) are mainly used. Among these, devices based on EXT2, NTFS, and FAT32 are dominant. The SBD aims to support these control devices.

All of these control devices have a tree directory structure, and a file is composed of a directory entry and a data block. The data block is larger than the sector in size. Accordingly, access control for the data block involves no problem. On the other hand, the directory entry (and a data structure involving it) is smaller than the sector in size, and thus the resolution of access control needs to be improved.

An improvement in the resolution of access control is implemented in the following procedure. Specifically, in this procedure, a required resolution is recorded in security information corresponding to a sector having been read, and access control information is read out in unit of the resolution (if the access control information cannot be stored in the additional disk without any processing, the access control information may be developed separately in another area). When the sector is written in the storage, processing of access control is performed in unit of the resolution (specifically, in the case of write prohibition, writing is performed using the data portion read out from the storage so as not to change the data stored in the sector).

As for write prohibition of a file, write prohibition needs to be set also for the path (route) from the root. This is because a file can be uniquely identified only when the path is included.

<Example of Access Control in EXT2 File System>

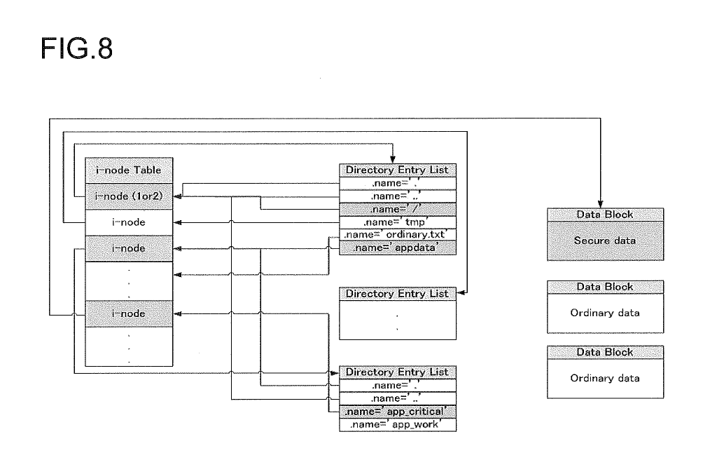

An example of access control performed by the SBD in EXT2 is illustrated in FIG. 8. In the figure, suppose that a file “app_critical” is write-prohibited. The SBD needs to set write prohibition also for data of the path name “/appdata/app_critical” from the root, which is illustrated in red in the figure.

The SBD needs to keep a caching system of the OS and the storage consistent with each other. In Linux, i-nodes, directory entries, and data blocks illustrated in FIG. 8 are cached in a memory, and are used as an i-node cache, a directory entry cache, and a buffer cache (corresponding to data of disk blocks)/page cache (corresponding to data of files), respectively. As preparation for accessing the file system, Linux reads out the superblock to the memory. The superblock stores layout information, the total number of free i-nodes, the total number of free blocks, and so on in the entire file system. The superblock structure on the memory stores a block group descriptor (storing layout information, the total number of free i-nodes, the total number of free blocks, and so on in a block group belonging to the same cylinder of the disk), a set of bitmaps of free blocks, and a set of bitmaps of free i-nodes. Linux utilizes these bitmaps and various caches to speed up file access. The superblock is regularly written back to the storage. Accordingly, if freeing the bitmap corresponding to a write-prohibited i-node or block is attempted also in the storage, the SBD can detect such an attempt (of course, in order to detect the attempt, the resolution of the bitmap area needs to be increased to units of bits, which can be implemented because the bitmap area is fixed). While Linux is modifying the file system on the memory, such a modification cannot be detected by the SBD until the modification is written to the storage, and when access control is performed at that time point, how Linux handles it is a problem (the problem occurs in the case of write prohibition). Timings at which writing is performed in the storage include writing back of various caches and the superblock; however, they occur in an order that is difficult to predict. A possible inconvenient scenario is as follows. A file that is write-prohibited in the storage is rewritten in the memory, and its i-node, directory entry, or data block is re-used for creation of another file, and after the file is written back from the memory to the storage, writing back of the original write-prohibited file occurs. In this case, because writing to the resource of the original file in the storage is prohibited, the corresponding part cannot be written when the file created re-using the resource is written back to the disk, and consequently the file may become corrupted.

<Considerations on Effective Access Control by SBD>

The above-described inconvenient scenario results from the fact that the SBD communicates with the OS only through low-level device JO. In the case of file access, the OS performs access control using a file attribute, it is not so difficult to modify the OS to receive access control information of a file from the storage device, and it is considered that this is one direction of making the OS more secure. Simpler measures will do for a simple OS which does not perform caching to a memory and reading of a bitmap.

The following gives possible operations in file access control performed by the SBD without modifying the OS irrespective of the sophistication level of the OS.

[Bottom line]: (The OS of the protection-target device is not affected)

It is possible to notify the system administrator of occurrence of a prohibited access operation via the SBD.

Means for disconnecting the network in the case of occurrence of access control violation is prepared.

(applications) A log regarding all IO ports is recorded in response to access control violation, and this record can be used to detect malware, determine the infection path, and so on.

[In the case of read prohibition]:

A dummy value is returned.

The OS at least does not operate erroneously if the name of a read-prohibited file within a directory is correctly shown and data is set to be a dummy value.

The name of a read-prohibited file within a directory is not displayed. Likewise, the OS does not operate erroneously.

If a read-prohibition bit is set (that is, access to a directory is prohibited), file names and pointers other than those of the target and its parent are not shown when a directory is accessed.

An IO error is returned. The OS may handle the error as a sector error.

No IO is returned. The storage device may be unmounted or the OS may freeze.

[In the case of write prohibition]:

Successful writing is returned. Inconsistency between data in the memory and data in the storage may occur, and consequently the issues described before may occur.

An IO error is returned. The OS may handle the error as a sector error.

No IO is returned. The storage device may be unmounted or the OS may freeze.

There may be circumstances where freezing would be preferably permitted rather than have malware taking control of the engineering PC through which programming is performed in the PLC or the like.

<Configuration of SBD>

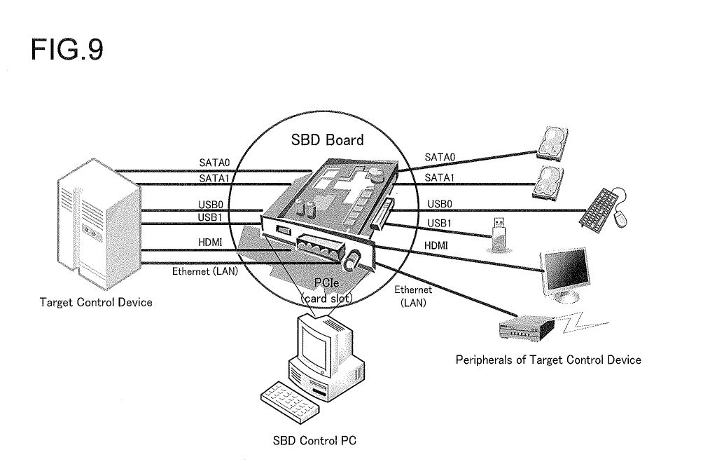

The SBD is, for example, a dedicated FPGA board having the following specs. An FPGA is used in order to perform processing of many ports with a small delay. In order to implement handling of a file system and a user interface, the SBD can be connected to a SBD control (host) PC by pci-express. Within a range that the board size permits, many ports for protection targets are mounted. A conceivable connection example is illustrated in FIG. 9. In applications in which downsizing is critical, the configuration can be replaced by USB connection to a smaller SBD control PC or an FPGA softcore processor can be alternatively used. In such a case, a keyboard and a display of a protection-target device are used in a switching manner by the FPGA, and the SBD directly issues an alert to the user terminal or a request to input a password. Also, a log regarding individual IOs is recorded, and, when security violation occurs, the log is utilized to determine the cause.

Board size: PCI Express card shape

FPGA chip: Xilinx Kintex-7 676 pins (XC7K325T)

Flash ROM for configuration: For writing a circuit to the FPGA at the time of power-on

Memory I/F: DDR3 SODIMM×1

Video input: HDMI×1 (without copy control HDCP)

Video output: HDMI×1 (without copy control HDCP)

Storage I/F: SATA (7 pins)×4/5 (SATA 3.0)

Communication I/F: 1 G/100 M-bit Ethernet (RJ-45)×2

General-purpose I/F: USB (Type A)×6 (USB 2.0)

SBD control PC I/F: PCI Express×1

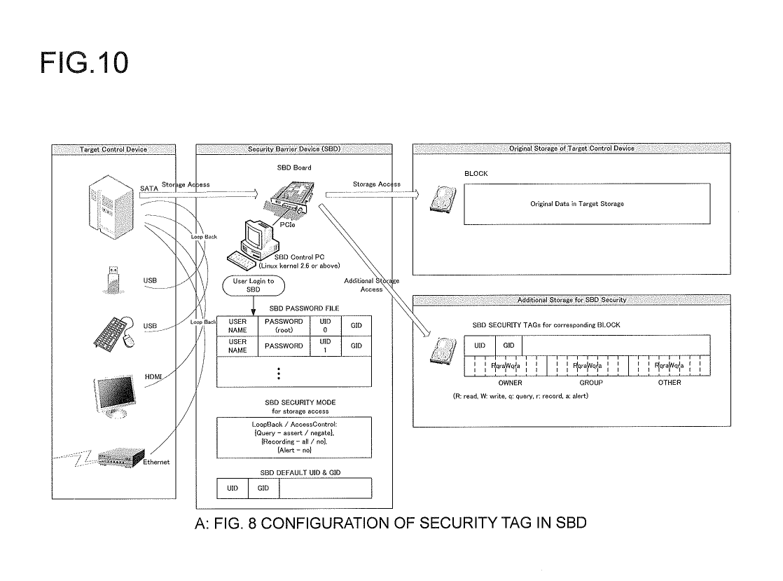

FIG. 10 illustrates the configuration of a security tag recorded in the security additional disk of the SBD. By logging into the SBD and making a configuration, access control different from user to user can be performed. The configuration is temporarily made such that data from ports other than the SATA port passes through (via the FPGA).

The following is a summary of the embodiment of the present invention described above.

The following is the configuration of an apparatus capable of enhancing security of existing systems such as PCs and control devices by being connected to the existing systems irrespective of the OS or application program. The security enhancement apparatus is an apparatus that relays JO of PCs, control devices, and so on. A hard disk, USB device, display, or the like just needs to be connected via the security enhancement apparatus, and thus the security enhancement apparatus can be easily added to the existing systems later. As for data protection in the storage, the present invention particularly discloses a method for handling data in units of files as well as units of sectors. Also, the apparatus directly performs secure data transfer or display, setting/input therefor, or the like, thereby being able to correctly make an alert or inquiry to the user even in the case where vulnerability of the OS or application program are attacked and control of the PC or control device is taken by an unauthorized program. Also, during communication, the apparatus can authenticate a communication-partner device and encrypt communication content.

The following description is related to means for performing access protection in units of files.

As means for specifying security such as write prohibition/write inquiry/read prohibition/read inquiry for data of a given size and a given number of pieces of data, a storage component for holding security information is prepared in addition to a storage component for holding data. For each unit of storage of the storage component for holding data, corresponding security information is held in the storage component for security information. In response to occurrence of a request to access data, security information corresponding to a storage area for holding the data is referred to, and an operation is performed in accordance with the security information. Alternatively, as another implementation method, the storage component for holding data is also used as the storage component for holding security information instead of preparing the storage component for holding security information separately from the storage component for holding data. Specifically, a portion of a storage area of the storage component for holding data is not used as a data area and is set as an area invisible from the user, and the security information may be held in the area.

As for an access violation notification and an access permission inquiry to the user, IO ports used therefor are connected to the PC via a unique apparatus of the present invention, just like the storage. This allows the security enhancement apparatus to directly make a notification or inquiry regarding IO of secure data using a display or touch panel usually used, independently of the PC side. Accordingly, no additional IO devices are needed.

The file systems differ from OS to OS, and there are many kinds of file system. In each of major file systems such as EXT2, FAT, and NTFS, in the case of implementing read prohibition, a sector storing data is checked, and read prohibition is recorded in security information therefor. When the sector is referred to, the security information corresponding to the sector is read out. If the security information indicates read prohibition, dummy data (all 0, for example) is returned or a read error is returned to the OS or application program.

On the other hand, in the case of implementing write prohibition, in the aforementioned major file systems, because a new file is separately created and rewriting of a directory is performed lastly depending on the application program, it is not sufficient to monitor only the sector storing data. That is, rewriting of directory data storing the write-prohibited file needs to be monitored. In these file systems, directories have a hierarchical structure, and it is necessary to guarantee that any part of the directory path from the root to the write-prohibited file is not modified. Note that because there are possibilities that each directory has a rewritable file or directory thereunder, only a pair of the name and data (or pointer used for storing the data) of the write-prohibited file needs to be write-prohibited in the directory. These are smaller than the sector (512 bytes in general), which is the minimum access unit of the disk, in size. Accordingly, a method for protecting this area is newly disclosed. Specifically, the method is a method for making the resolution of security information higher for a directory area and allowing write prohibition and write permission to coexist within a sector.

First, as for how to make the resolution of the security information higher, a required resolution is recorded in security information corresponding to a sector having been read, and access control information is read out in unit of the resolution (if the access control information cannot be stored in the additional disk without any processing, the access control information may be developed separately in another area). When the sector is written to the storage, processing of access control is performed in unit of the resolution (specifically, in the case of write prohibition, writing is performed using the data portion read out from the storage so as not to change the data stored in the sector).

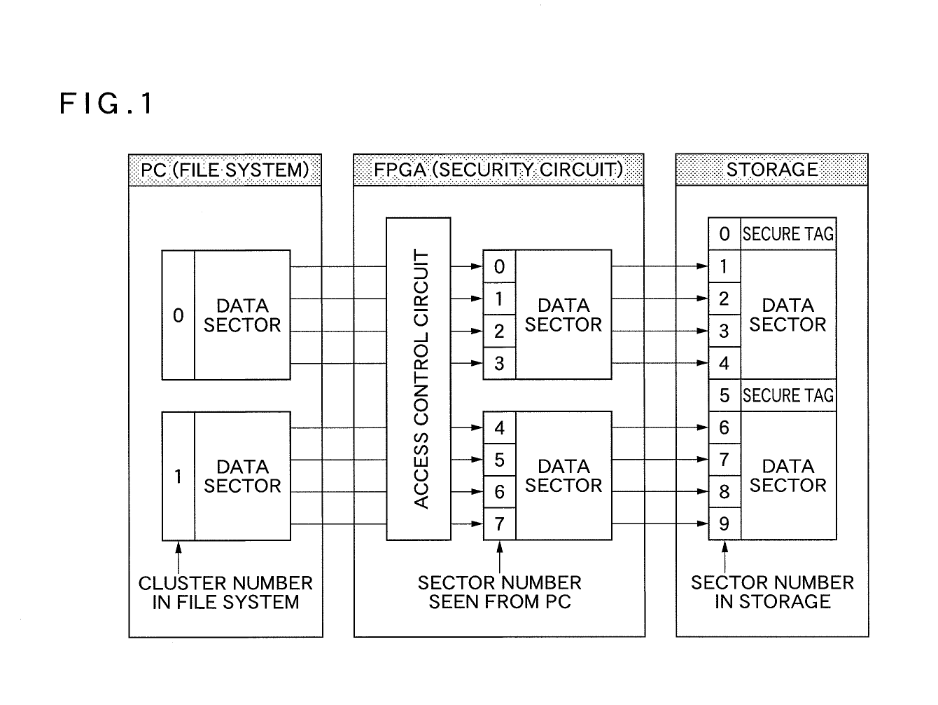

As a security enhancement apparatus according to a first embodiment of the present invention, the case where a storage such as a hard disk that performs access in units of sectors is used as the storage component and the data area and the security information area are allocated in the same storage is illustrated in FIG. 1. The PC is connected to an FPGA (chip in which a logic circuit has been written) instead of the hard disk. In response to data access, the circuit on the FPGA refers to the security information of a secure tag, and performs write prohibition or read prohibition processing. Although not illustrated in the figure, in the case where an IO for the user is connected to the FPGA, an inquiry may be made to the user as to whether or not to permit data access using it. In the figure, a cluster of the file system visible from the PC is composed of four data sectors. This is the same as the case of directly using an ordinary hard disk or the like, and it is impossible to determine whether or not the protection function is provided from the PC side. Control of the secure tag and access protection is performed by the security circuit of the FPGA, and cannot be performed from the PC.

The present invention implements access control in the file system. That is, in the case of write protection, not only data of a file but also the entire path name (/appdata/app_critical in the figure) from the root are protected (write-prohibited) as illustrated in FIG. 8. To this end, the resolution needs to be made higher so as to make units of write protection smaller than units of sectors. Accordingly, the above-described method is used and the present invention implements finer security information and a logic circuit supporting it.

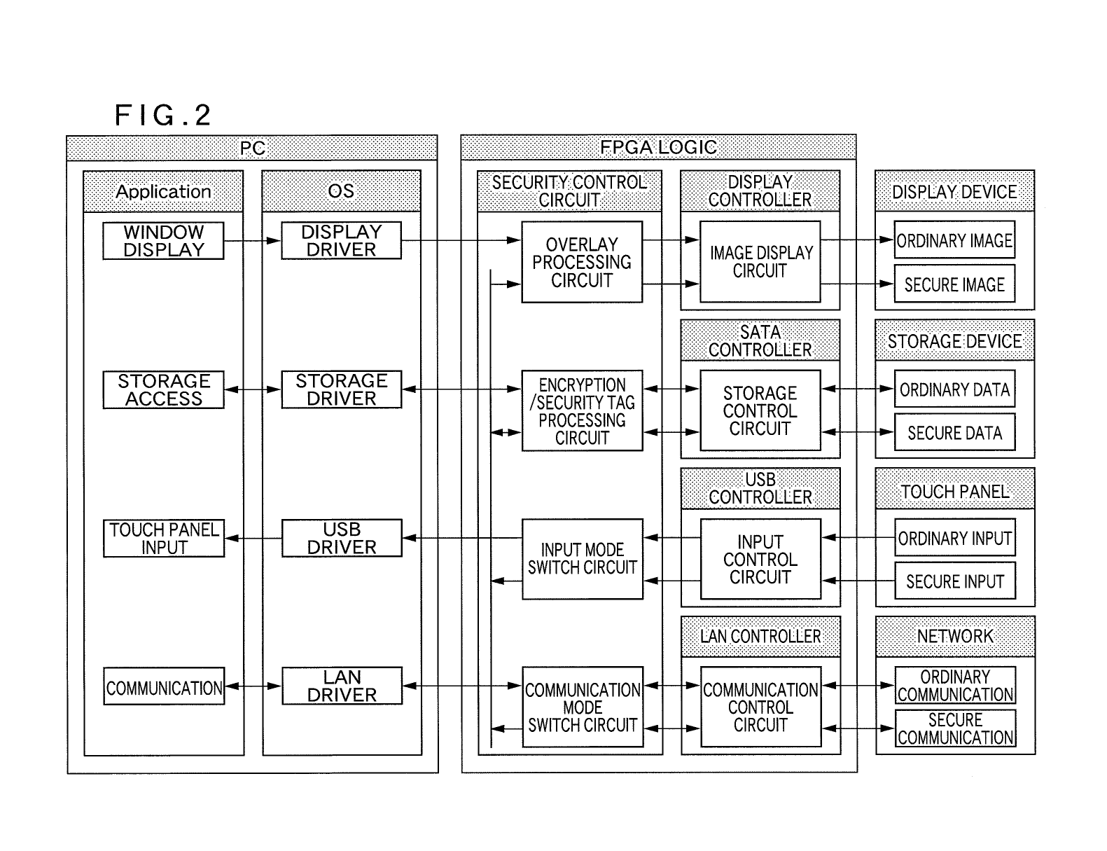

As a security enhancement apparatus according to a second embodiment of the present invention, a method for implementing secure access to a display, a touch panel, and a network as well as the storage is illustrated in FIG. 2. These storage, display, touch panel, and network appear to be the same as the ordinary ones without the protection function from the OS or program on the PC. However, as for access to these, the circuit on the FPGA discriminates between ordinary access and secure access. In this way, secure data can be exchanged without via the OS or application program. For example, occurrence of access violating data protection may be directly displayed on the user's display, the user is requested to give permission to access the data, and a data protection setting may be changed directly from the circuit on the FPGA. As for communication, the FPGA can perform direct secure communication independently of general communication, and thus coordination between a plurality of apparatuses of the present invention, exchange of secure data, and so on can be performed. Also, in the case where access violating the protection setting occurs for a data area or file, invasion to the system or infection by malware is suspected, and thus the network visible from the PC or control device can be disconnected and further infection can be prevented by cooperative operation between IO ports. Even in such a case, secure communication can be performed. Conversely, in the case where an attack from the network is detected, measures such as issuing an alert to user and raising the protection level of the storage area so as to permit access to a narrower limited range can be implemented.

As described above, the configuration of the apparatus capable of enhancing security of existing systems such as PCs and control devices by being connected to the existing systems irrespective of the OS or application program is disclosed. The security enhancement apparatus is an apparatus that relays IO of PCs, control devices, and so on. A hard disk, USB device, display, or the like just needs to be connected via the security enhancement apparatus, and thus the security enhancement apparatus can be easily added to the existing systems later (see FIG. 9). As for data protection on the storage, the present invention particularly discloses the method for handling data in units of files as well as units of sectors. Also, the apparatus directly performs secure data transfer or display, setting/input therefor, or the like, thereby being able to correctly make an alert or inquiry to the user even in the case where vulnerabilities of the OS or application program are attacked and control of the PC or control device is taken by an unauthorized program. Also, during communication, the apparatus can authenticate a communication-partner device and encrypt communication content.

While the embodiments of the present invention have been described in detail above, the present invention is not limited to the embodiments above. Various design alterations can be made to the present invention as long as such alterations do not deviate from matters described in the scope of claims. Because the SBD is a hardware device, the SBD is not detectable by malware. By analyzing the IO log in response to detection of unauthorized access to data, the SBD is useful to discover malware of new type. A storage rollback function can also be implemented. Communication security can also be implemented. Further, applications in various circumstances, such as an experiment of a display device of new type, are expected.

<Concept of SBD and Mechanism of Data Protection>

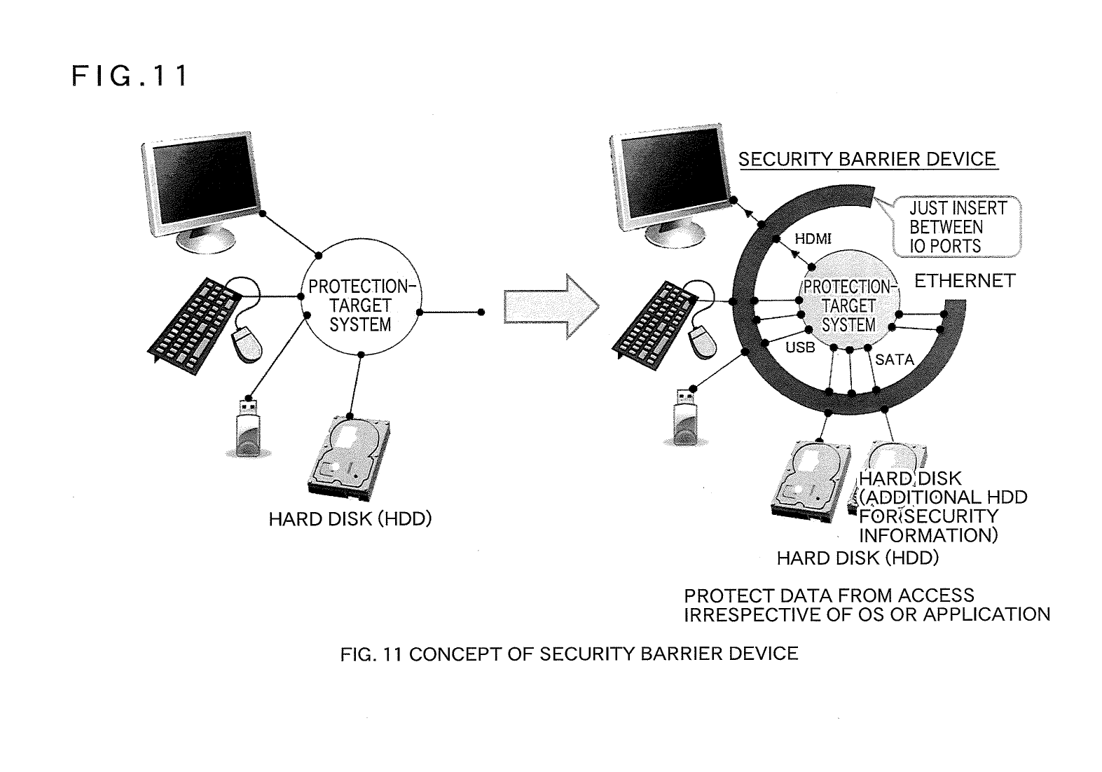

The SBD is hardware that is inserted between a motherboard of a protection-target device (hereinafter, simply referred to as a system) such as a PC or control device and peripheral devices, and that interconnects/monitors these devices so as to protect these devices (FIG. 11). Ports that are interconnected/monitored by the SBD are of SATA, USB, Ethernet, HDMI, and optical audio. The SBD does not require installation of software such as a driver, and can be connected irrespective of the OS or application of the PC to be protected. The protection function of the SBD covers these IO ports in general. The following is a description regarding a storage protection function implemented by the SBD by interconnection of SATA ports.

A basic operation scheme of the storage protection function of the SBD is as follows. An original hard disk storing data of the PC is connected to the SBD. The SBD separately has a security information disk made accessible thereto only, and holds access permission information for data blocks of the original disk therein. In response to a data access request from the PC to the original disk, the SBD refers to the access permission information for the portion, and performs reading or writing if access is permitted. However, if reading is prohibited, the SBD returns dummy data such as 0, or if writing is prohibited, the SBD does not perform writing.

<Connection Form to Hardware of SBD>

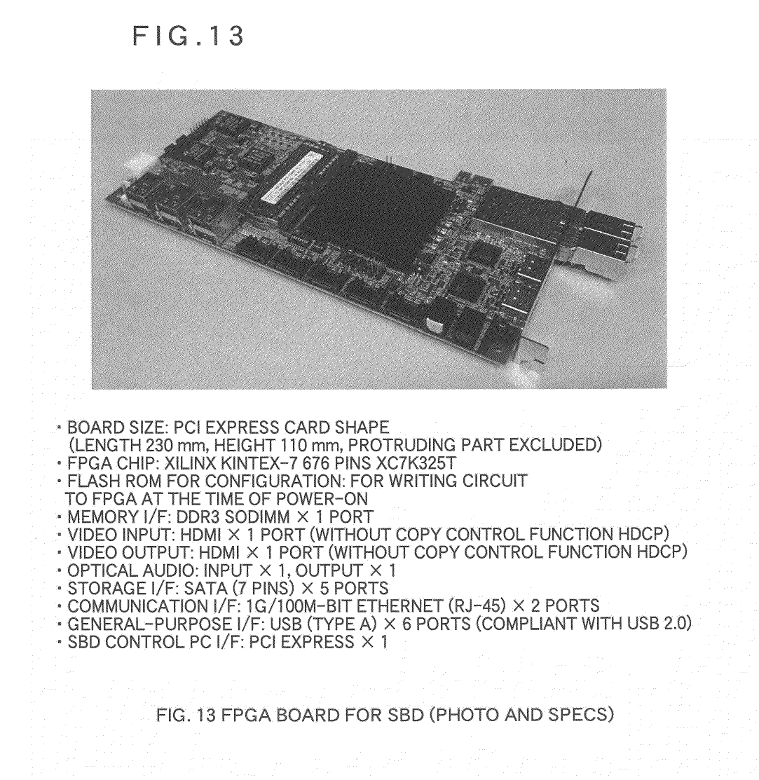

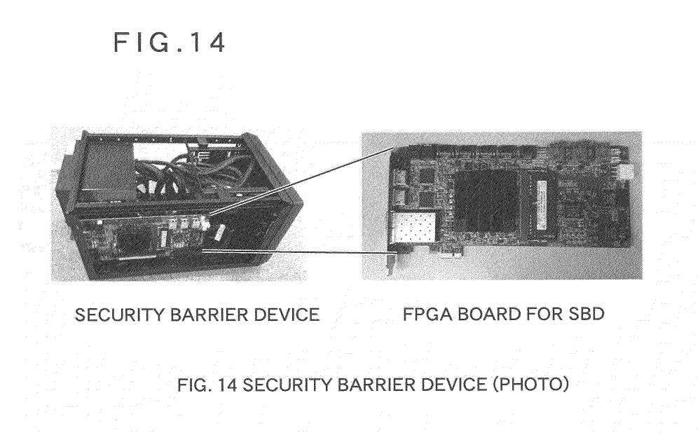

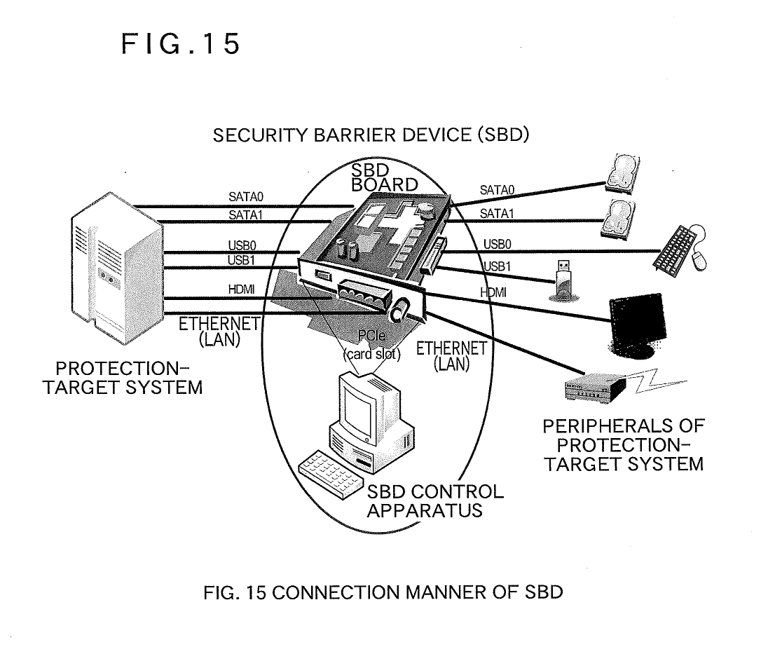

The SBD is constituted by an FPGA board (FIG. 13) that is originally developed for speedup and interconnection/monitoring of various IO ports and a control apparatus therefor (FIG. 14). The control apparatus is an ordinary PC that operates on Ubuntu, and is connected to the FPGA board by PCI-express. FIG. 15 illustrates how the SBD is connected.

<Necessity of Access Control in Units of Files>

For access control in units of sectors, i.e., unit of access of the disk, the SBD just needs to hold access information for each address of a corresponding sector, and thus the implementation mechanism is simple. This enables protection in units of partitions. However, in order to protect a file by using this mechanism, a work for collecting data and system files that should not be rewritten to a write-prohibited partition and collecting data that should not usually be read out to a read-prohibited partition is needed. If protection in units of files can be done, the convenience improves significantly.

The system and important data are files in many cases

Files need not be moved to a protected partition

It is possible to protect the original data disk without any processing

It is extremely easy to specify or cancel a protection-target file

No stress is incurred for connection and disconnection of the SBD (only connection and disconnection to a connector)

<Requirements for Access Control in Units of Files>

Files systems used often are

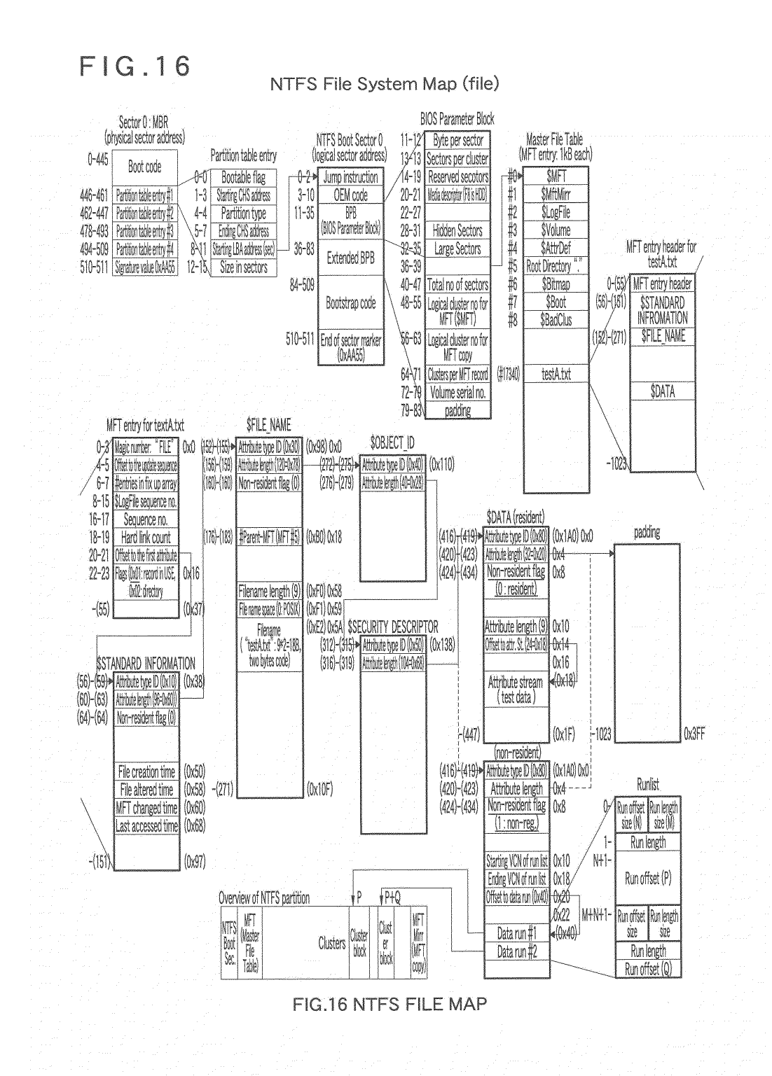

NTFS (Windows series),
EXT series (Linux series), and
FAT series (old Windows, MS-DOS, VxWorks, USB memory, etc.). In these files systems, first, the following is considered as for access control of data blocks (FIG. 16).

IO can be done in units of sectors

As for read protection, 0 or the like can be returned in response to reading of the block.

As for write protection, in the case of a non-resident file, if a pointer pointing to the data block or pointers of parent directories to the file are changed, such a change makes it impossible to access the data block and causes a failure. Access control is needed also for directories.

Access control in units of files requires access control of a pointer area within a file or within a directory; however, the size of the pointer area is smaller than the sector size (512 B), and thus some measures are needed.

<Making Resolution of Access Control Higher than that of Units of Sectors>

Access control in units smaller than units of sectors can be implemented using the following method. Specifically, content of a sector having been read is compared with content of the sector to be written by the SBD on a byte-by-byte basis; if the pieces of data in units of bytes have the same content, it is determined that the data is not rewritten; if the pieces of data have different contents, it is determined that the data is rewritten. This determination is made by a logic circuit of the FPGA. This allows a disk which is a block device to be handled in units of bytes with a small overhead. Note that an improvement of a circuit that suppresses performance degradation caused by the increase in resolution is needed. Accordingly, a circuit that performs comparison of sectors by masking the sectors at the resolution, a buffer circuit that collectively performs disk IO of a plurality of sectors, or the like is used.

<Access Control in Units of Files: Remaining Issues> Challenging Issues still remain in terms of implementation of access control in units of files. Specifically, in the case where write prohibition is performed,

[1] content of the disk cache stored in the memory of the PC becomes different from content stored on the disk, and thus the file system may become corrupted and the OS may crash (as described in detail before as for Linux); and
[2] also, in order to set write prohibition for a file, part of the path from the root (that is, a set of directories to the file) related to the file needs to be write-prohibited; however, in NTFS, pointer entries to files within a directory are managed using the balanced tree algorithm, and the position of the entry of the write-prohibited file may change owing to addition or deletion of an ordinary file. The SBD achieves a higher speed using the circuit on the FPGA that assumes protection of a fixed area, and supporting a variable area leads to the performance penalty.

<Access Control in Units of Files: Solutions to Issues>

These issues are solved by testing and observing operation of the Windows kernel program that manages NTFS using the SBD. Specifically,

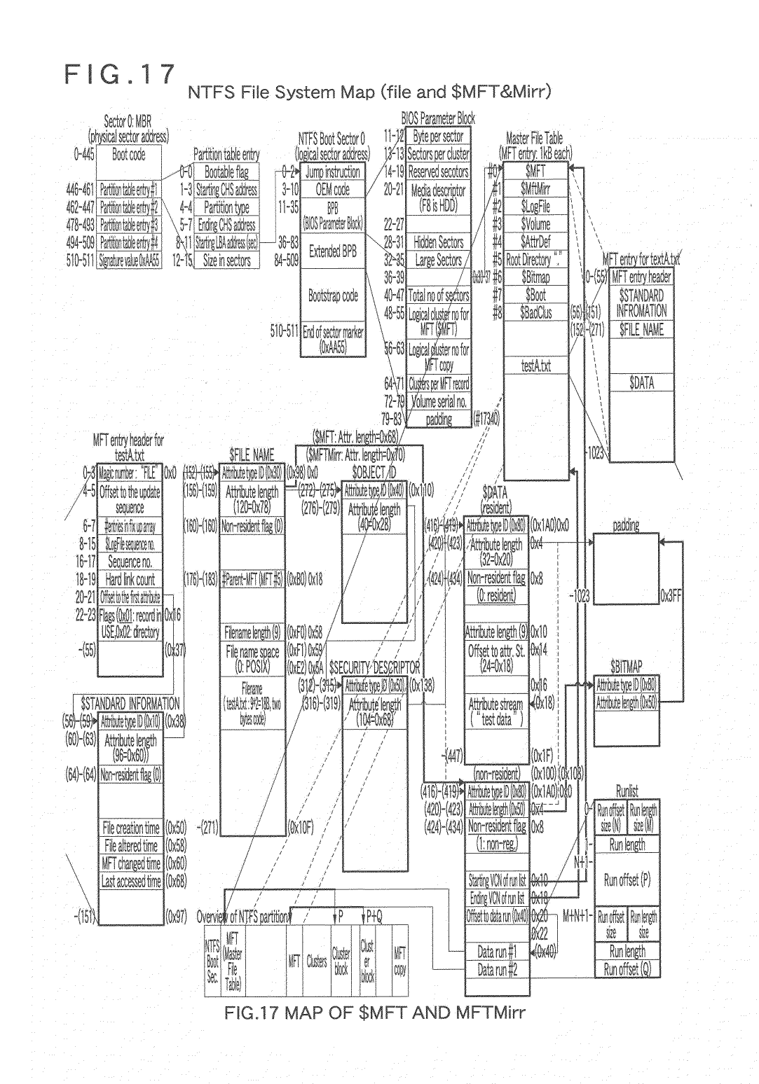

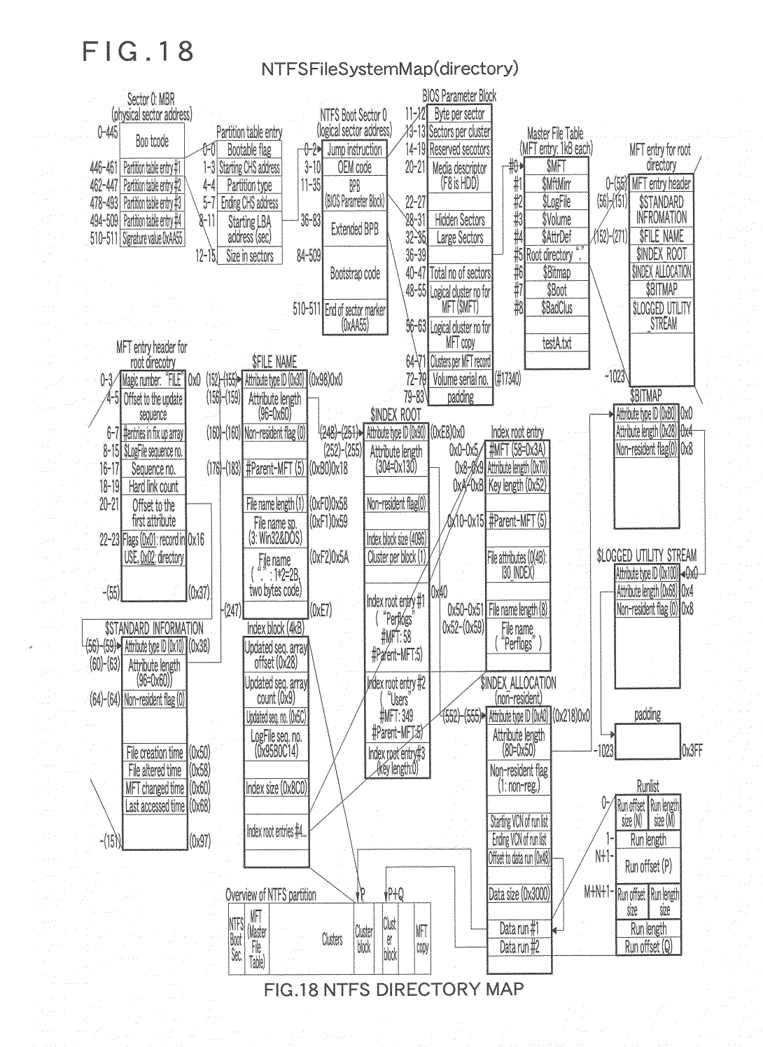

As for [1], consistency with file system management of the OS is successfully achieved by intentionally causing a pseudo-bad block. Specifically, when the SBD returns an error in response to the disk IO, Windows considers the data block to be bad, and records the data block in $BadClus (FIG. 17).
As for [2], the fact that a pointer pointing to a parent directory within a file is fixed is utilized. For a child file, there is one parent directory, and the parent directory does not change unless the path is changed (FIG. 18). During rebooting of the OS, the pseudo-bad block caused by the SBD in [1] is retrieved, and the file can be restored to the original state using the pointer pointing to the parent directory.

In the case where writing, renaming, deletion, or the like is performed on a write-prohibited file, the operation completes in the disk cache on the memory first, and it seems that rewriting has been successful. However, shortly thereafter, the change is written to the disk, and this is detected by the SBD. The SBD performs the processing described above, and also notifies the user that write-prohibition violation has occurred. The SBD can also disconnect Ethernet in response to the violation. If the user reboots the OS, the SBD performs a file recovery operation, the write-prohibited file is restored to the original state, and the PC returns to the original state.

<Protection by SBD from Malware>

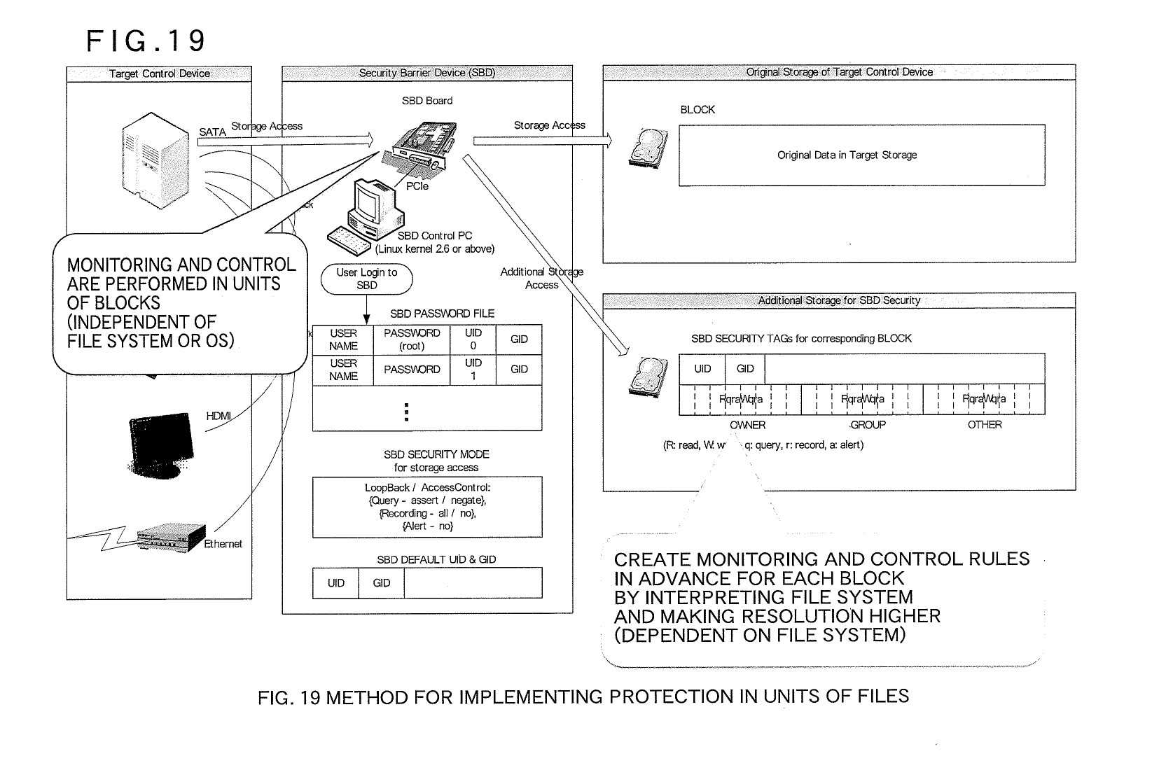

The SBD is capable of setting read/write protection or making an inquiry to the user for a given number of areas of a given address or a given size (either is in units of bytes currently) in a disk connected to the SATA port. In addition to this protection in units of areas, protection in units of files is also made possible. A method for implementing protection in units of files is illustrated in FIG. 19. By interpreting the file system and making a configuration in advance, monitoring of access control violation is performed by the FPGA board using a physical address at a high speed. The file system is implemented by NTFS of the current Windows series; however, EXT of the Linux series and FAT for small-scale storages can also be handled. As applications of the above-described storage protection function, by setting write prohibition for a boot data area, system files, or the like that are not to be rewritten usually, protection from malware which involves modifications of these can be expected. Also, it is possible to set an area or file to be subjected to read protection or a user inquiry, and prevention of careless breaches of confidential information can be expected. Further, detection of access violation such as reading and writing is useful for discovering malware including zero-day type. It is also possible to disconnect Ethernet in response to detection of access violation, and terminate a remote operation. Prevention of further attacks from the outside, information breaches, infection to other systems can be expected. Because the security information disk is invisible from the protection-target system, the malware cannot change this security information in principle.

1. A security enhancement apparatus that makes a resolution of security information higher than a resolution of sectors which are units of IO of a block device, and that implements access control of write prohibition or read prohibition in areas smaller than the sectors.

2. The security enhancement apparatus according to claim 1, wherein
the security enhancement apparatus is capable of setting a specified file to be a write-prohibited file, and in a case where there is a write request for the write-prohibited file, does not perform writing for the write-prohibited file, and that information about the request is recorded and a user is notified that the request has been prohibited.

3. The security enhancement apparatus according to claim 1, wherein the security enhancement apparatus is capable of setting a specified file to be a write-prohibited file, and in a case where there is a write request for the write-prohibited file, does not perform writing for the write-prohibited file, and returns an error to an OS in response to the IO request so as to cause the OS to perform processing for a pseudo-bad block; the OS registers an entry of the file to a pseudo-bad block list (a $BadClus file in NTFS); a user is notified that write-prohibition violation has occurred; after the user reboots the OS and before the OS becomes ready, the entry of the write-prohibited file is retrieved from the pseudo-bad block list of the OS, is registered as an ordinary file so as to restore the file, and further a path to a root is restored by tracking a pointer pointing to a parent directory of the file, and the write-prohibited file that has been written is fully restored to the original.

4. The security enhancement apparatus according to claim 1, wherein
the security enhancement apparatus is capable of setting a specified file to be a read-prohibited file, and in a case where there is a read request for the read-prohibited file, does not perform reading in an area of the read-prohibited file, and that dummy data is returned, information about the request is recorded, and a user is notified that the request has been prohibited.

5. The security enhancement apparatus according to claim 1, wherein
the security enhancement apparatus is capable of setting a specified data file to be subjected to a write inquiry or read inquiry, and has a function of making an inquiry to a user as to whether or not to permit writing or reading in a case where there is a write request or read request for the data file, and of performing writing or reading only in a case where permission is returned.

6. The security enhancement apparatus according to claim 1, comprising
as means for specifying security of write prohibition/write inquiry/read prohibition/read inquiry for a given number of files or a file of a given size, a storage component for holding security information in addition to a storage component for holding data, the security enhancement apparatus characterized in that, for each unit of storage of the storage component for holding data, corresponding security information is held in the storage component for holding security information, and in a case where a request to access the data occurs, the security enhancement apparatus refers to the security information corresponding to a storage area for storing the data and operates in accordance with the security information.

7. The security enhancement apparatus according to claim 6, wherein
the storage component for holding data is also used as the storage component for holding security information, a portion of a storage area of the storage component for holding data is an area that is not used as a data area and is invisible from a user, and the security information is held in the area.

8. The security enhancement apparatus according to claim 1, wherein
various IO ports are directly controlled by hardware so that the control is not sensed from an OS or application program on a PC, the control of the IO ports is mutually coordinated based on information obtained from the IO ports, and in a case where there is an access violating a protection setting for a data area or file, a network visible from the PC and a control device is disconnected and secure communication can be performed even in such a case.
